(19) United States
(12) Patent Application Publication
(10) Pub. No.: US 2010/0180828 A1
(43) Pub. Date: Jul. 22, 2010

(54) Portable Pet Refreshment Device

(76) Inventor: Paul Christopher DeMichael, Murphy, NC (US)

Correspondence Address: Paul Christopher DeMichael, 325 Tarheel West Drive, Murphy, NC, 28906, US

(21) Appl. No.: 12/356,197

(22) Filed: Jan. 20, 2009

(51) Int. Cl. A01K 7/00

(52) U.S. Cl. 119/72

(57) ABSTRACT

A single-serving, liquid or water filled, disposable container, particularly suited to provide portable refreshment for pets during walking or exercising. The device includes an integrated clip, particularly suited for easy attachment and removal from a pet's leash, pet owner's belt loop, fanny-pack, pocketbook, exercising equipment, etc. To provide pet refreshment, the device is unclipped from its tether, and a peel-back lid reveals the liquid, provided in a flat-bottomed container, suitable for placement on ground or floor. When the pet has consumed the liquid, the device can be discarded. The intention is for the device to be provided in multi-packs, and that all materials used can be recycled. The container size and serving portion are intended to be enough to provide refreshment, but must be lightweight enough to not hinder either the pets or owners movement during walking or exercising.

### INTRODUCTION

The present invention relates to animal watering devices, and specifically to provide pet refreshment during walking or exercise. Even on brief outings, pets may show signs of dangerous dehydration, due to temperature or increased physical activity. Often overlooked, due to weight, physical size, portability, or convenience, is a way to refresh the pet quickly and easily. This invention is designed to provide a convenient, low-cost solution that is currently unavailable in today's marketplace. Designed as small, lightweight, single-serving containers, they can be easily attached to the pet's leash, or clipped to the owner's belongings. By utilizing a peel-back lid, the liquid can be quickly dispensed to the thirsty pet. By keeping the physical container, and therefore portion size modest, it ensures both portability, easy storage, low cost, and convenience.

### SUMMARY OF THE INVENTION

This disposable liquid container is pressed or molded from cellulosic, thermoplastic, or metallic material into a one-piece, thin-walled dish with a flat bottom, with flat or tapered sides. This container includes a flanged tab with a hole, through which a fastening clip is placed. The flange will be of sufficient size to support the weight of the device as it moves without tearing. The opening of the container will be of sufficient size to allow pet to easily consume the content. The opening of the container has sufficient flange to allow for a liquid-tight paper, plastic, or foil lid, which is affixed to the flange with water-tight adhesive. This lid with will include sufficient overhang material to serve as a pull tab, which is commonly grasped between thumb and index finger, to allow easy removal and disposal from the unit. It is preferred that the container is filled with one and one-half ounces of liquid, but can be manufactured to contain between one-quarter to six ounces of liquid.

The container is preferably affixed to a tethering device by way of a clip made from thermoplastic or metallic material that is supplied with each multipack. The clip will be of sufficient size and construction to allow for several containers to be attached at the owner's preference.

### BRIEF DESCRIPTION OF THE DRAWINGS

FIG. 1 is a top view of the portable pet refreshment device according to the present invention, shown with lid in closed position, and attachment clip.

FIG. 2 is a side view of the portable pet refreshment device according to the present invention, shown with lid in closed position, and attachment clip.

FIG. 3 is a bottom view of the portable pet refreshment device according to the present invention, shown with attachment clip.

FIG. 4 is a perspective view of the portable pet refreshment device according to the present invention, with the lid shown in fully closed and sealed position, and attachment clip.

FIG. 5 is a perspective view of the portable pet refreshment device according to the present invention, with the lid shown in the partially open and unsealed position, and attachment clip.

FIG. 6 is an environmental, perspective view of the portable pet refreshment device according to the present invention, shown unsealed and in typical use.

FIG. 7 is an environmental view of the portable pet refreshment device according to the present invention, shown with clustering of inventions on attachment clip during typical use.

FIG. 8 is an environmental view of the portable pet refreshment device according to the present invention, shown tethered to pet leash as may appear in typical use.

FIG. 9 is an environmental view of the portable pet refreshment device according to the present invention, shown with clustering of inventions as they might appear presented for retail sale in typical use.

### DETAILED DESCRIPTION OF THE PREFERRED EMBODIMENTS

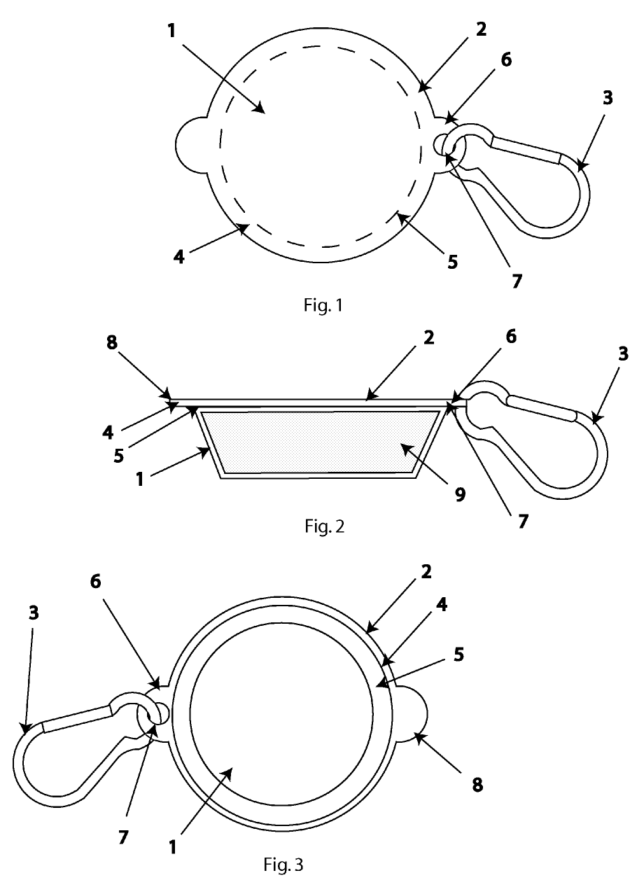

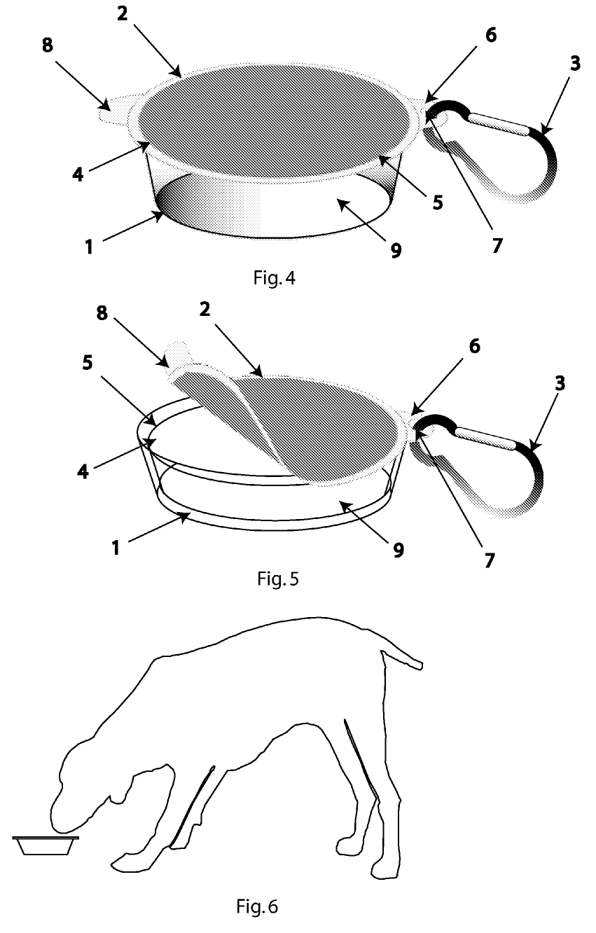

As detailed in FIG. 1 thru FIG. 5, the device consists of four components. A disposable liquid container 1 of pressed or molded cellulosic, thermoplastic, or metallic material fashioned into a one-piece, thin-walled dish with a flat bottom, with flat or tapered sides. This container includes a flanged tab 6 with a hole 7, through which a fastening clip 3 is placed. The flange 6 will be of sufficient size to support the weight of the device as it moves without stress related fracture or tearing. The opening of the container 5 will be of sufficient size to allow pet to easily consume the liquid content 9. The opening of the container 5 has sufficient flange 5 to allow for a liquid-tight paper, plastic, or foil lid 2, which is affixed to the flange 5 with water-tight adhesive 4. This lid 2 with include sufficient material to serve as a starting pull tab 8, to allow easy removal and disposal from the unit.

The preferred embodiment is that the container 1 is filled with one and one-half ounces of liquid content 9, but can be manufactured to contain between one-quarter to six ounces of liquid content 9.

The preferred embodiment diameter of the container opening 5 is two and one-half inches, but can range from one to six inches in diameter.

The preferred embodiment is that the lid 2 is of a flexible, waterproof material of either foil, plastic, or coated paper, but can be of any material suitable to maintain waterproof integrity, while protecting liquid content from leakage and contamination.

The preferred embodiment of the height of the container 1 is a measure of one inch, but can range from one-quarter to three inches in height from top to bottom.

The preferred embodiment of the container 1 affixing to a tethering device FIG. 8 is by way of a clip 3 made from thermoplastic or metallic material that is supplied with each multipack FIG. 9, but can be secured to tethering device through alternate means, including fabric or synthetic straps, hook and loop connectors, cables, tie wraps, and various other means by using natural or synthetic connector devices.

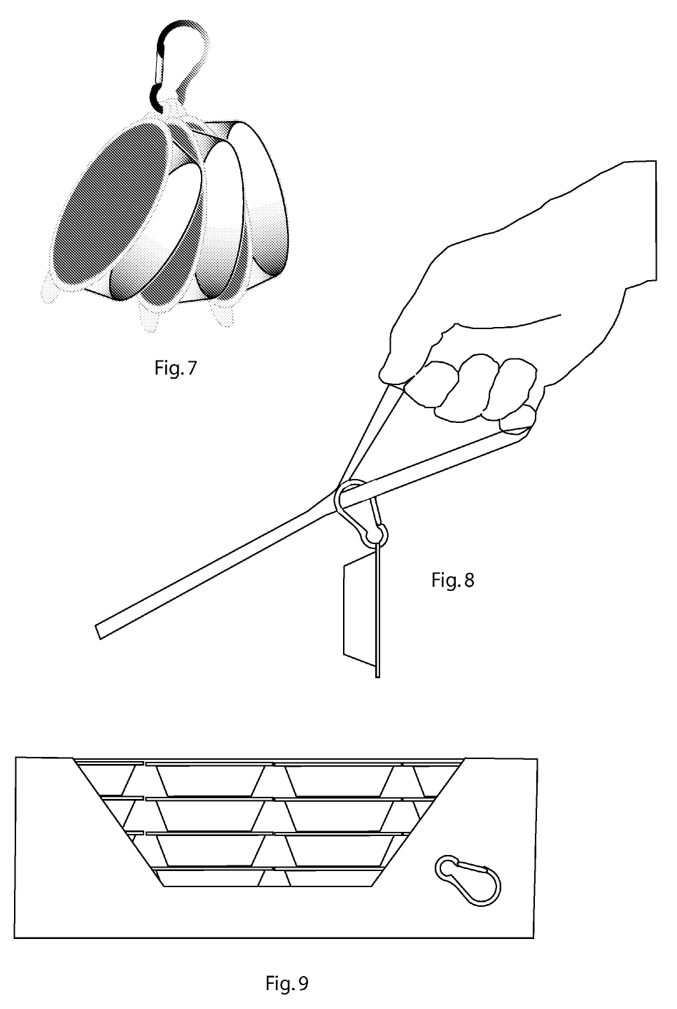

The preferred embodiment of clip 3 will be of sufficient size and construction to allow for several containers FIG. 7 to be attached at the owner's preference.

The preferred embodiment of liquid content 9 is water, but additional liquids suitable for safe pet consumption, including fruit and vegetable juices, vitamin and nutrient enriched liquids, etc. can be used. While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.

What is claimed is:

1. A portable, disposable, single serving, pet refreshment device comprised of four components—a watertight container, removable lid, liquid content, and fastening clip. The container consists of a molded or pressed, thin walled, symmetrical form capable of storing water or liquid, with the bottom of said container being flat and having a flange at the opening for lid attachment and having an integrated tab flange with hole to secure connection clip. A lid with integrated pull tab, which is attached to the container flange with adhesive to create a water-tight seal, an integrated pull tab, which serves to remove the lid from the container. A liquid content consisting of water or juice. A fastening clip, which attaches to the container flange, wherein the container can be affixed to pet harness, belt loop, pocketbook, or any other device of owners preference, with the design to readily interfit with like members for being compactly packaged in multiple numbers.
